(19) United States
(12) Patent Application Publication
(10) Pub. No.: US 2016/0185656 A1
(43) Pub. Date: Jun. 30, 2016

(54) AUTOMOTIVE GLAZING WITH ENAMEL PATTERNS

(71) Applicants: Sophie DANNEELS, Gosselies (BE); Fabien DESCAMPS, Gosselies (BE)

(72) Inventors: Sophie DANNEELS, Gosselies (BE); Fabien DESCAMPS, Gosselies (BE)

(73) Assignee: AGC GLASS EUROPE, Louvain-la-Neuve (BE)

(21) Appl. No.: 14/238,676

(22) PCT Filed: Jul. 3, 2012
(86) PCT No.: PCT/EP2012/062889

§ 371 Date: Feb. 12, 2014

(30) Foreign Application Priority Data
Aug. 12, 2011 (BE) 2011/0493

(51) Int. Cl. C03C 17/04; C03B 23/025; C03B 23/023

(52) U.S. Cl. CPC C03C 17/04; C03B 23/023; C03B 23/0252

(57) ABSTRACT

The invention concerns automobile glazing comprising an enamel coating on at least part of the surface thereof, said coating acting as a barrier against light transmission. The glazing is characterised in that the enamel coating reflects more than 10%, and preferably more than 15%, of wavelengths higher than 800 nm.

The present invention relates to automotive glazing units comprising enamel patterns.

Glazing units comprising an enamelled section provide special features with respect to some thermal, bending or toughening treatments or with respect to the properties of the glazing units in question. The following focuses on the aspect relating to thermal treatments but also on the properties resulting from the characteristics of these glazing units.

In automotive glazing units it is customary in particular to arrange an enamelled zone along the edges of the glazing unit. The presence of this enamelled zone is associated with masking the beads of glue that secure the glazing to the body of the vehicle. This is the case, for example, with windscreens, rear windows, rear quarter panels or glazed roofs. Reference will be made below to windscreens or roofs on the understanding that the invention applies to all glazing units that comprise opaque or substantially opaque enamelled sections.

The presence of enamel bands modifies the local behaviour of the glass sheets with respect to transfers of heat during their shaping. The reason for this is that these enamels disposed on essentially transparent glass sheets are themselves largely opaque to visible radiation but above all to infrared radiation.

The transfers of heat in the bending or toughening furnaces are mostly linked to radiation while a not inconsiderable portion can be of the convection type. The radiation mode of heat transfer is primarily concentrated in the near (789-2500 nm) or far (more than 2500 nm) infrared range and to a lesser extent in the visible range.

Clear glass absorbs infrared radiation, but while this absorption is significant, in particular when its temperature increases, it remains lower than that observed for opaque enamelled products, in particular when the colour thereof is very dark, which is the case with the product used most frequently for the masking operations referred to above.

The difference in absorption of infrared radiation by the enamelled sections of the glazing compared to that of the non-enamelled sections leads to difficulties in controlling the temperatures of the sheets during thermal treatments. More specifically, the difficulty lies in the need to have temperatures that are quite specific and different depending on the parts of the surface of the sheets in question, and the presence of absorbent enamel bands partly influences the temperature of the glass in these coated sections.

The bending of the sheets can be conducted using different techniques. Nevertheless, in all cases the presence of the enamelled sections plays a part in the thermal conditioning of the sheets. Of these techniques, the ones most sensitive to the establishment of precise temperature conditions are those that comprise at least in part a step of shaping by “gravity”. In these techniques, the shaping of the glass is conducted under the effect of its own weight when the glass is at its softening temperature. In this case, since the glass sheets are only supported on their periphery, the forces acting on them locally are more significant at the edge than at the centre of the sheets and this leads to a more significant deformation that makes it difficult to obtain the desired shape. This type of difficulty is encountered from the instant part of the process comprises a deformation by gravity, even if the technique also includes auxiliary methods such as a localised partial pressing operation.

The success of the shaping operation is achieved by managing local temperature conditions at different points on the surface of the sheets, wherein a higher temperature benefits a more severe deformation and vice versa.

In the gravity shaping operation conducted on a support frame the edges must be maintained at a lower temperature than that of the centre of the sheets. To achieve this result, the absorption of the glass is traditionally controlled by locally transferring a portion of the heat supply to the elements that accompany the glazing during the bending operation and/or by modifying the distribution of the radiation over the bent sheet or sheets by the addition of infrared sources.

For example, “thermal masses” consisting of metal plates are distributed over the circumference of the support of the sheets. These thermal masses absorb a controlled portion of the infrared radiation compared to the zones of the sheets coated with enamel that are capable of absorbing more heat than the adjacent non-coated zones. This method of control is not perfectly satisfactory even though it allows bent forms with the desired essential geometric characteristics to be obtained. In practice, adapting the thermal masses to the absorption needs requires multiple tests and substantial experience in this field. However, the presence of these thermal masses has other disadvantages.

Thus, the accumulation of heat in the frames containing these masses prolong the process that after bending leads to consolidation of the shapes by lowering the temperature. Apart from the sheets the frames and these thermal masses must also be cooled. In the same way, the stored energy, which is then dissipated during the cooling, does not contribute to the bending operation and increases the total consumption.

The invention proposes to respond at least in part to the outlined difficulties relating to the production of glazing units comprising enamelled sections and, if need be, to improve the properties of these glazing units.

The invention proposes glazing units such as those forming the subject of claim 1.

In the case of the glazing units according to the invention, enamel compositions must be chosen that while providing a substantial opacity to the coated parts, limit the absorption of infrared radiation of these coatings.

A portion of the infrared radiation is thus reflected. For the shaping of the glazing units the reflected portion must not exceed what would lead to an inadequate heating of the glasses located beneath these enamels in relation to the incident IR rays. The limit in question is dependent on various parameters that are associated with the configuration of the furnace, the arrangement of the radiation sources, the equipment on which the glass sheets are located and the glass sheets themselves. In practice, in the configurations and for the most usual glass sheets, according to the invention the reflection of the enamelled sections measured in accordance with standard ISO 9050 (illuminant A at 2°) preferably does not exceed 30% of wavelengths of more than 800 nm, and more usually not more than 25% of these wavelengths.

The glazing units according to the invention must at the same time exhibit a light transmission that corresponds to the type of glazing considered: windscreen, rear window, roof, side windows . . . , but also wherein the sections comprising an enamel coating are essentially opaque to the visible range. The masking function in the case of these enamelled sections leads to a light transmission of the visible range of practically zero. This transmission must be less than 1% and generally is less than 0.1% measured in accordance with standard EN 410. This only concerns the coated sections. The glazing units often have enamelled sections as edging consisting of borders composed of dots providing progressive masking. These borders have a transmission that decreases from the non-coated section of the glazing to that in which the enamel layer is uniform.

The glazing units intended for the automotive field must meet the characteristics that regulations or practice demand for these uses. In general, the reflection in the visible wavelengths of the glazing must not be too high to maintain a favourable light transmission of the transparent sections, but also so as not to create a mirror effect. Moreover, the enamelled sections must not exhibit too high a reflection of the visible range.

In the case of the enamelled section the reflection in the visible range (Renamel) measured in accordance with standard EN 410 preferably must not exceed 25%, particularly preferred must not exceed 20% and advantageously is not higher than 10%.

It is generally desirable that the reflection of the glazing in the visible range does not exhibit a substantial difference between the sections that are coated and those that are not (Rglass). This difference is advantageously less than 10% and preferably less than 5%.

The implementation of the invention in bending techniques allows better local control of the temperature of the shaped sheets and most particularly in the steps of modifying the sheets under the effect of their own weight.

If, as indicated above, differences in temperature are necessary between the peripheral zones coated with enamel (Tenamel) and those that are not coated (Tglass), these differences must nevertheless be well controlled. In practice, they do not exceed 30° C. and preferably are not higher than 25° C.

The invention is advantageously applicable whether the bending has been conducted entirely by gravity or whether the process includes elements for shaping by pressing the sheets, in particular pressing operations that only concern certain sections of the glazing, as is often the case for glazing units that locally have very pronounced curves.

The implementation of the invention is particularly useful when the bending operation is conducted simultaneously on two sheets intended for a subsequent assembly using a thermoplastic interlayer sheet of polyvinyl butyral (PVB) for instance.

The glass sheets included in the composition of laminated glazing units have enamelled sections either on face 2 or on face 4 in accordance with the traditional designation that results in numbering the faces of the glass sheets from that directed towards the outside of the vehicle.

In the operations of bending two glass sheets by gravity these sheets rest on a support frame which supports the sheets on their periphery. In this configuration the enamelled sections can be located either between the two glass sheets or on the face of the upper sheet directly exposed to infrared rays. The choice between these two positions is in part at least dependent on the enamel and its treatment.

No particular precaution is necessary when the enamel is on the upper face. The applied layer cannot be subjected to any treatment prior to being inserted into the bending and/or toughening furnace. The coating goes through different curing stages as the temperature increases. The first stage leads to the elimination of the most volatile solvents and possibly of organic constituents forming part of the composition of the enamel pastes. These modifications as well as the stabilisation of the mineral constituents, referred to as sinterisation, terminates what constitutes the pre-curing. At this stage the coating is no longer “sticky”. In the remainder of the process, with the temperature of the glass sheets continuing to increase, the frit contained in the enamel paste is brought to its melting point and the glass sheets reach their softening state, which leads to bending. Throughout this process the enamel composition is only in contact with the atmosphere. It is not likely to be displaced or impaired.

When the enamel is located on one of the faces of the sheets that are in contact with one another during the course of the bending, it is necessary to ensure that it is pre-cured until the enamel layer is rendered non-“sticky” before the glass sheets are superposed to prevent any transfer of enamel by contact of one sheet with the other. The pre-curing operation thus requires an additional separate treatment.

The simultaneous bending of two sheets also leads in certain cases to a reversal of the sequence of the sheets in the final assembled glazing unit. Once the bending has been achieved, the sheet in the upper position during the bending operation is placed underneath for the assembly. This allows the operation to proceed with the enamel coating exposed to the atmosphere on the upper sheet during the bending operation. In other words, the curing can be conducted as in the first case indicated above, with or without pre-curing of the enamel while having the enamel in position 2 in the laminated glazing.

The invention is applicable to all glazing units irrespective of the thickness of the sheets or their possible colour. It has particularly noticeable advantages for the bending of sheets of smaller thickness. Controlling the thermal conditions for these sheets is a delicate matter because of their low thermal inertia. It is therefore very useful to improve this control by implementing the measures of the invention.

Controlling of the thermal conditions involves in particular the cooling conditions of the glazing units intended to give them the necessary stresses, in particular the edge stresses, which influence the mechanical strength of the glazing units. The desired stresses come from the cooling kinetics of the surface of the sheets in relation to the kinetics existing in the core of the sheets. The difference in the rate of cooling generates the stresses in question. In the distribution of the stresses, those located on the edges of the glazing units are the most noticeable.

In the case of thin glazing units it is difficult to carry out the cooling maintaining an adequate temperature gradient in the thickness of the sheets. The cooling must be very rapid. Rapid cooling is all the more difficult to achieve when the glass sheets are located in an environment having a more significant quantity of stored heat. It has been emphasised above that one of the methods implemented systematically in glazing units bent by gravity to improve the distribution of temperatures was to arrange thermal masses in particular to face the edges of the glazing. These thermal masses are traditionally integral to the support used for the bending by gravity. While these masses assure a good distribution of the temperatures, they add to the inertia that reduces the cooling rate. As will be indicated in the examples in the following description, implementation of the invention enables these thermal masses to be significantly reduced. In consequence, the application of enamel reflective of IR thus leads to an improvement in the toughening of thin glasses.

Apart from the interest associated with the technique of shaping glass sheets, the use of enamels that reflect infrared rays also provides advantages for the glazing units obtained. In particular, in the case of automotive glazing units the application of enamels with the characteristic of reflecting a significantly higher proportion of infrared rays compared to traditional masking enamels allows the heating of the elements of the glazing or of those in contact with this glazing to be reduced when these glazing units are exposed to solar radiation.

As an indication, reduced heating of the enamelled edges of a glazing unit prevents the adhesives gluing the glazing to the body of the vehicle from ageing too rapidly. This is particularly noticeable in the case of glazing units that are greatly exposed to solar radiation, as is the case with roofs. Moreover, the use of the products according to the invention allows improvement of the protection of heat-sensitive functional elements that these glazing units can comprise in the direct vicinity of, and possibly partially beneath, these enamelled sections. This is the case, for example, with materials that form part of the composition of some glazing units, in which the light transmission is electrically controlled, in particular those including particles such as so-called “SPD” (suspended particle device) cells.

The invention is described below with reference to the attached set of drawings:

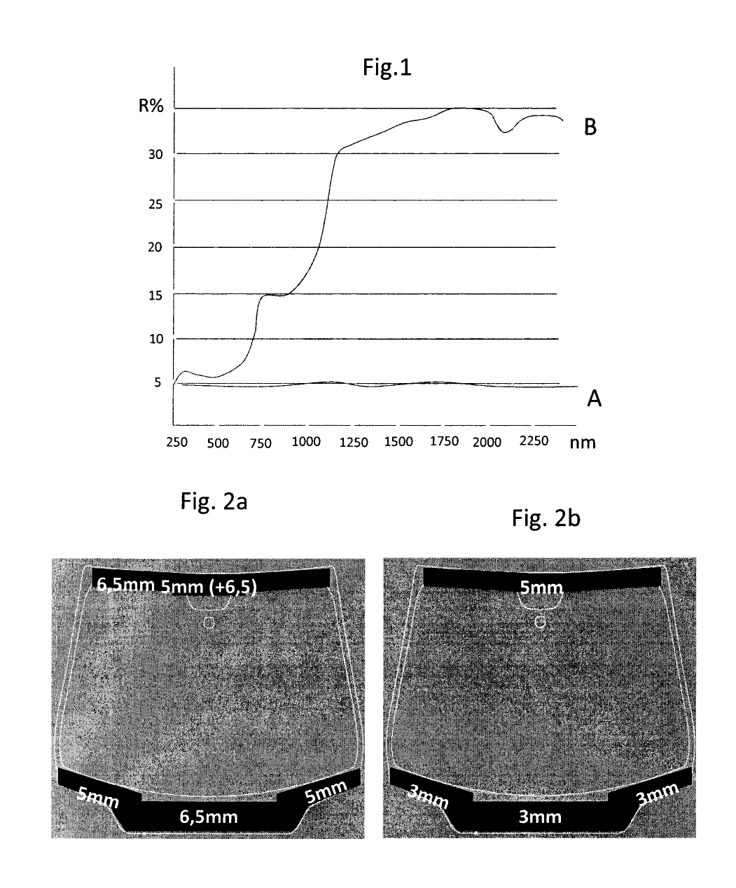

FIG. 1 shows reflection spectra for applications of enamels using standard techniques and according to the invention;

FIG. 2a shows the state of the thermal masses necessary for a shaping operation on the frame of a windscreen design pattern with a standard enamel;

FIG. 2b shows the state of the thermal masses necessary for the same windscreen with an enamel edging according to the invention.

FIG. 1 illustrates a comparison of the reflection spectra as a function of the wavelengths of enamels traditionally used in the case of automotive glazing units, on the one hand, and enamels that meet the criteria of the invention, on the other.

All the enamels used are based on mineral pigments. The pastes applied contain solvents, binders and frit in addition to dark-coloured pigments based on metal oxides, in particular iron oxide.

With respect to the enamels that exhibit IR reflection, there are commercially available pigments such as e.g. the pigment “Sicopal Black K 0095” from BASF. This pigment based on iron or chromium oxide is well suited to being incorporated into pastes intended for application to glass sheets to form opaque patterns.

The pastes are applied to a sheet of ordinary float glass. The enamel is pre-cured at about 180° C. for 6 min to sinter it. It is then brought to 630° C., the temperature corresponding to that reached during bending operations for glass sheets. This temperature is higher than that necessary to melt the frit and finish the curing process.

For all compositions the application of the paste results in an enamel layer with a thickness of 40μ.

Reflection measurements are conducted by exposing the enamel layer directly to radiation, wherein the glass only serves as support.

The traditional enamel composition exhibits a practically uniform reflection A over the entire infrared spectrum. The reflection level is in the order of 5%. The spectrum of the enamel corresponding to the invention B exhibits a very rapidly increasing reflection for wavelengths higher than 750 nm. This reflection increases to a level located at about 35%.

To determine the effect of this reflection on the behaviour of glass sheets, the two samples are placed flat and side by side in the open air facing a source of infrared radiation of limited intensity. The two samples are exposed in an identical manner. The temperature rise of the glass sheets is measured. In the test conditions the temperature stabilises after 10 min of exposure.

The temperature of the sample coated with traditional enamel amounts to 92° C., that of the enamel having increased infrared reflection settles at 77° C.

Therefore, a noticeable difference is obtained in the case of exposure to low-intensity infrared radiation. This mechanism is applied in a series of tests relating to the bending of glass sheets of a windscreen design pattern.

The shaping operation is conducted entirely by gravity on the two superposed sheets. The cut out sheets are placed horizontally on frames intended to support their periphery during the bending operation. The whole assembly of the frame and two sheets is inserted into a so-called tunnel furnace, in which the temperature increases progressively to reach the sagging temperature of the glass with a good distribution of temperature over the surface of the sheets. The advance in the furnace should be sufficiently quick for reasons of economic efficiency. The sojourn time in the furnace until sagging of the sheets that have just been applied against the frame that supports them amounts to 12 min in the present case.

With respect to the distribution of temperatures over the surface of the sheets, it is important to ensure that the sections subjected to the most significant forces of gravity do not undergo excessive deformation compared to that of the central sections of the sheets. To prevent any undesirable deformation, the temperature must be lower on the edges of the glass sheets.

The control of temperatures in the case of the windscreen design pattern, which is illustrated in FIGS. 2a and 2b, leads to differences of about ten degrees being maintained between the centre of the sheets and the edges thereof, about 625° and 615° C. respectively. In this example both sheets consist of ordinary float glass and each has a thickness of 2.1 mm.

In this example the enamel is applied to the edges of the upper sheet on the face directly exposed to the radiation. Once bending has been completed, the sequence of the sheets is reversed during the final assembly.

The width of the enamel band varies depending on its location. It is in the order of 2.5 cm on the side edges, 5 cm at the top of the windscreen with an extension of up to 15 cm at the location of the supports for the rear view mirror and rain or light sensors, and about 16 cm at the bottom of the windscreen.

In order to reach the temperature profile that prevents excessive deformations close to the edges, the support frames used are provided with thermal masses consisting of steel plates. These plates arranged beneath the glass sheets are in substantially parallel planes to these sheets. The presence of these plates is necessary facing the sections comprising the widest enamel bands at the top and bottom of the windscreen with a particularly noticeable point corresponding to the location for fastening the rear view mirror and the difference sensors.

The presence of the plates absorbing part of the radiation prevents excessive localised heating during the process of increasing the temperature in the bending furnace.

FIGS. 2a and 2b show the location and the form of the thermal masses in relation to the glass sheets. The thickness is indicated in millimetres on each plate.

The choice of the masses is such that the result obtained is practically identical or even improved in the case of the invention with respect to the shape obtained, but also the optical and mechanical characteristics of these glazing units.

FIG. 2a shows the case of use of traditional enamel of low reflection. The thickness of the plates serving as thermal masses appears all the more significant when these are under the widest enamel zones. Still relating to this example, the most noticeable point is that at the centre of the top section where? two superposed plates are necessary amounting to a thickness of 11.5 mm.

The same windscreen using an enamel, the reflection of which is that indicated above, leads to the use of a frame comprising the plates shown in FIG. 2b.

In the practical example of the invention for identical conditions of passage in the furnace all the thermal masses have reduced thicknesses. The development is particularly noticeable in the fastening zone for the rear view mirror. In this zone the thickness of the plate changes from 11.5 mm to 5 mm. However, all the plates have their thickness reduced by at least 2 mm.

The reduction of the thermal masses allows easier maintenance of the equipment, but above all results in a reduction in energy consumption. A proportion of the energy consumed is in fact used for heating these thermal masses. The energy thus consumed does not contribute to the operation of heating the glass. It is lost in that after bending of the sheets and exit from the furnace the frames are cooled to ambient temperature in the circuit that leads them to a new cycle of use.

In the case in question, the energy consumption associated with the increase in temperature of the thermal masses is in the order of 10% of that used for heating the glass itself and about 1.5% of the total energy consumed in the furnace. Therefore, the reduction in these masses in the order of 30% allows a reduction in the total energy consumption in the order of 0.5%.

1. An automotive glazing, comprising: an enamel coating on at least one section of a surface of the glazing as a barrier to light transmission,
wherein the enamel coating exhibits a reflection of wavelengths of more than 800 nm of not less than 10%.

2. The glazing according to claim 1, wherein the light transmission of the section coated with the enamel coating is less than 1%.

3. The glazing according to claim 1, wherein an infrared reflection of the enamel coating does not exceed 30%.

4. The glazing according to claim 1, wherein the section coated with the enamel coating is as least localised to a periphery of the glazing.

5. The glazing according to claim 1, wherein the section coated with the enamel coating exhibits a reflection rate in a visible range Renamel that does not exceed 25%.

6. The glazing according to claim 5, wherein a difference between reflection rates in the visible range Renamel and Rglass does not exceed 10%.

7. A bending process, comprising: subjecting at least one glass sheet comprising a section coated with an enamel coating as a barrier to light transmission to a bending operation,
wherein the enamel coating exhibits a reflection of wavelengths of more than 800 nm of not less than 10%.

8. The process according to claim 7, wherein
the bending operation is conducted at least in part by gravity,
the glass sheet coated with the enamel coating are supported by a support on periphery of the glass sheet during the bending operation, and
the support is located under the section coated with the enamel coating.

9. The process according to claim 8, wherein during the bending operation, a difference between the highest temperature of the section coated with the enamel coating Tenamel and the highest temperature of section not coated with the enamel coating Tglass does not exceed 30° C.

10. The process according to claim 7, wherein
a top glass sheet and a bottom glass sheet arranged one on top of the other are bent simultaneously, and
the top glass sheet alone bears an enamelled section on a surface that is not in contact with the bottom glass sheet.

11. The glazing according to claim 1, wherein the enamel coating exhibits a reflection of wavelengths of more than 800 nm of not less than 15%.

12. The glazing according to claim 1, wherein the light transmission of the section coated with the enamel coating is less than 0.1%.

13. The glazing according to claim 1, wherein the section coated with the enamel coating exhibits a reflection rate in a visible range Renamel that does not exceed 20%.

14. The glazing according to claim 5, wherein a difference between reflection rates in the visible range Renamel and Rglass does not exceed 5%.

15. The process according to claim 8, wherein during the bending operation, a difference between the highest temperature of the section coated with the enamel coating Tenamel and the highest temperature of section not coated with the enamel coating Tglass does not exceed 20° C.
